(19) United States
(12) Patent Application Publication
(10) Pub. No.: US 2025/0018800 A1
(43) Pub. Date: Jan. 16, 2025

(54) VEHICLE CONTROL SYSTEM

(71) Applicant: HONDA MOTOR CO., LTD., Tokyo (JP)

(72) Inventor: Shotaro Yamazaki, Tokyo (JP)

(21) Appl. No.: 18/766,698

(22) Filed: Jul. 9, 2024

(30) Foreign Application Priority Data
Jul. 13, 2023 (JP) 2023-115042

(51) Int. Cl. B60L 3/10; B60L 7/26

(52) U.S. Cl. CPC B60L 3/108; B60L 3/102; B60L 7/26; B60L 2240/465; B60L 2240/80

(57) ABSTRACT

A vehicle control system includes an electric braking control unit that controls a hydraulic pressure generating unit, a behavior control unit that controls each brake mechanism, a front motor control unit and a rear motor control unit that control respective rotating electric machines, and an integrated control unit. The behavior control unit blocks the flow of a working medium of the hydraulic pressure generating unit to each front brake mechanism when a slip has occurred at the front wheels during execution of regenerative braking by the front motor control unit. The electric braking control unit increases the pressure of a pressure medium of the hydraulic pressure generating unit compared to when no slip has occurred at the front wheels.

### CROSS-REFERENCE TO RELATED APPLICATION

Priority is claimed on Japanese Patent Application No. 2023-115042, filed Jul. 13, 2023, the content of which is incorporated herein by reference.

### BACKGROUND OF THE INVENTION

### Field of the Invention

The present invention relates to a vehicle control system.

### Description of Related Art

Efforts to provide access to sustainable transportation systems that take into account vulnerable people such as the elderly, people with disabilities, and children among transportation participants have increased in recent years. To achieve this goal, attention has focused on research and development to further improve traffic safety and convenience through development of vehicle behavior stability.

A control device that predicts the start of activation of anti-lock braking control and increases a friction braking force and reduces a regenerative braking force in advance to prevent a sudden decrease in deceleration caused by a delay in the response of the friction braking force is known in the related art (for example, see Patent Document 1 below).

[Patent Document 1] Japanese Unexamined Patent Application, First Publication No. 2012-35840

### SUMMARY OF THE INVENTION

However, regarding vehicle behavior stability, it is a challenge to, when a slip of wheels has occurred during deceleration due to regenerative braking, eliminate the slip while preventing insufficient braking force and vehicle behavior instability.

For example, the control device of the related art described above controls the friction braking force and the regenerative braking force prior to the start of activation of anti-lock braking control. However, it is difficult to accurately predict vehicle behavior that changes depending on the traveling road surface, braking conditions, or the like and thus there a risk of not being able to ensure an appropriate braking force. For example, there is a risk that the braking force may be insufficient due to pressure fluctuations caused by valve opening and closing in a hydraulic pressure circuit for friction braking when the regenerative braking force is replaced with the friction braking force as anti-lock braking control is activated.

Aspects of the present invention have been made in view of such circumstances and it is an object of the aspects of the present invention to provide a vehicle control system capable of preventing insufficient braking force and vehicle behavior instability when eliminating a slip of wheels and thus to contribute to the development of sustainable transportation systems.

The present invention adopts the following aspects to solve the above problems and achieve the object.
(1) A vehicle control system according to an aspect of the present invention includes a rotating electric machine control unit configured to control an operation of a rotating electric machine configured to transmit and receive torque to and from a predetermined wheel and a friction braking control unit configured to control an operation of a pressure system configured to drive a friction brake mechanism of a plurality of wheels including the predetermined wheel using a pressure medium, wherein the friction braking control unit is configured to, when a slip of the predetermined wheel has occurred during execution of regenerative braking by the rotating electric machine control unit, block a flow of the pressure medium to the friction brake mechanism of the predetermined wheel and increase a pressure of the pressure medium compared to when the slip of the predetermined wheel has not occurred.
(2) In the above aspect (1), the friction braking control unit may be configured to set the pressure of the pressure medium in association with a friction braking torque obtained by multiplying a decrease in a regenerative braking torque by which the rotating electric machine control unit has reduced the regenerative braking torque by a predetermined coefficient while the flow of the pressure medium to the friction brake mechanism of the predetermined wheel is blocked when a slip of the predetermined wheel has occurred to increase the pressure of the pressure medium compared to when the slip of the predetermined wheel has not occurred.
(3) In the above aspect (1) or (2), the friction braking control unit may be configured to, when the blocking of the flow of the pressure medium to the friction brake mechanism of the predetermined wheel has been released, terminate control of increasing the pressure of the pressure medium, compared to when the slip of the predetermined wheel has not occurred, after a predetermined period of time elapses.

According to the above aspect (1), the friction braking control unit can promote the elimination of the slip of the predetermined wheel by blocking the flow of the pressure medium to the friction brake mechanism of the predetermined wheel. The friction braking control unit can prevent the total friction braking force of the vehicle from becoming insufficient by increasing the pressure of the pressure medium flowing to the friction brake mechanism of the wheels other than the predetermined wheel compared to when the slip of the predetermined wheel has not occurred. The friction braking control unit can prevent insufficient braking force and vehicle behavior instability when eliminating the slip of the predetermined wheel.

In the case of the above aspect (2), the rotating electric machine control unit can promote the elimination of the slip of the predetermined wheel by replacing the regenerative braking torque of the predetermined wheel with a friction braking torque of the wheels other than the predetermined wheel. The friction braking control unit can prevent the total braking force (the sum of the friction braking force and the regenerative braking force) of the vehicle from becoming insufficient by increasing the pressure of the pressure medium such that the friction braking torque of the other wheel includes a shortage of the friction braking torque due to the blocking of the flow of the pressure medium to the friction brake mechanism of the predetermined wheel when the regenerative braking torque is replaced with the friction braking torque.

In the case of the above aspect (3), the friction braking control unit releases the blocking of the flow of the pressure medium to the friction brake mechanism of the predetermined wheel when the slip of the predetermined wheel has been eliminated, such that the friction braking control unit can prevent the total friction braking force of the vehicle from becoming excessive by terminating the control of increasing the pressure of the pressure medium. The friction braking control unit can prevent sudden fluctuations in the friction braking force and vehicle behavior instability by reducing the pressure increase of the pressure medium to zero after a predetermined period of time elapses.

### BRIEF DESCRIPTION OF THE DRAWINGS

FIG. 1 is a configuration diagram of a vehicle control system in an embodiment of the present invention.

FIG. 2 is a block diagram showing a functional configuration of the vehicle control system in the embodiment of the present invention.

FIG. 3 is a configuration diagram of a hydraulic system in a vehicle control system of the embodiment of the present invention.

5 FIG. 4 is a diagram showing an example of a correspondence relationship between the speed of a vehicle, a valve close flag, a braking force, a pressure of the hydraulic system, and a braking torque in the vehicle control system of the embodiment of the present invention.

FIG. 5 is a diagram showing an example of a correspondence relationship between a valve close flag and the pressure of the hydraulic system in the vehicle control system of the embodiment of the present invention and a comparative example.

### DETAILED DESCRIPTION OF THE INVENTION

Hereinafter, a vehicle control system according to an embodiment of the present invention will be described with reference to the accompanying drawings.

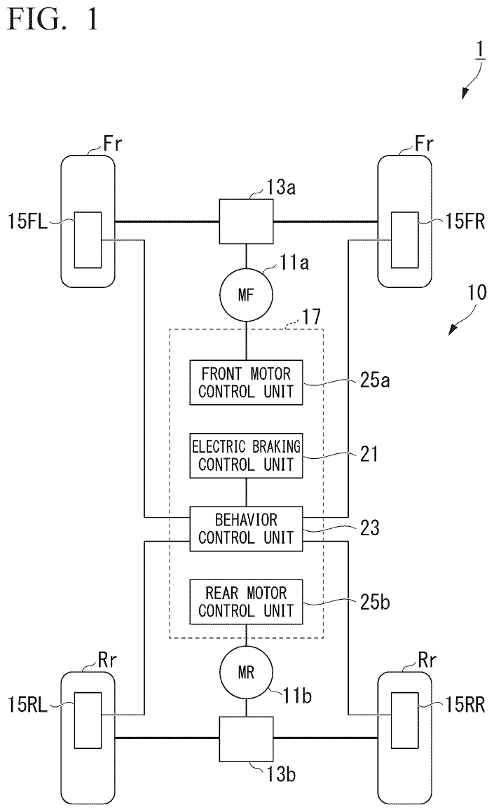

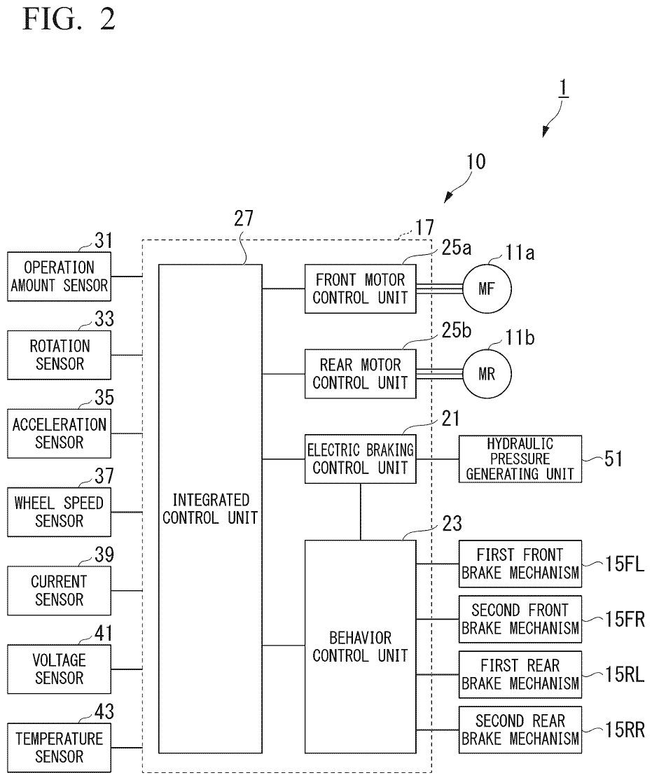

FIG. 1 is a configuration diagram of a vehicle control system 10 in the embodiment. FIG. 2 is a block diagram showing a functional configuration of the vehicle control system 10 in the embodiment.

The vehicle control system 10 of the embodiment is mounted, for example, in an electric vehicle (a vehicle) such as an electric vehicle, a hybrid vehicle, and a fuel cell vehicle. An electric vehicle is driven using a battery as a power source. A hybrid vehicle is driven using a battery and an internal combustion engine as power sources. A fuel cell vehicle is driven using a fuel cell as a power source.

The vehicle in which the vehicle control system 10 is mounted is, for example, a front-wheel drive vehicle including a rotating electric machine that generates power for the front wheels, a rear-wheel drive vehicle including a rotating electric machine that generates power for the rear wheels, or an all-wheel drive vehicle including a rotating electric machine that generates power for the front and rear wheels.

As shown in FIGS. 1 and 2, a vehicle 1 in which the vehicle control system 10 is mounted includes, for example, a front rotating electric machine 11a, a rear rotating electric machine 11b, a front differential device 13a, a rear differential device 13b, a first front brake mechanism 15FL, a second front brake mechanism 15FR, a first rear brake mechanism 15RL, a second rear brake mechanism 15RR, and a processing device 17.

The front rotating electric machine 11a transmits and receives torque to and from left and right front wheels Fr, for example, via the front differential device 13a. The rear rotating electric machine 11b transmits and receives torque to and from left and right rear wheels Rr, for example, via the rear differential device 13b. Each of the rotating electric machines 11a and 11b is, for example, a three-phase AC brushless DC motor. The rotating electric machines 11a and 11b perform a motoring operation using electric power supplied from a power conversion device or the like to generate driving torques respectively for the wheels Fr and Rr. The rotating electric machines 11a and 11b perform a regenerative operation using rotational power received respectively from the front wheels Fr and the rear wheels Rr to generate electric power and generate a regenerative braking torque respectively for the front wheels Fr and the rear wheels Rr.

The front differential device 13a connects, for example, the front rotating electric machine 11a and the left and right front wheels Fr. The rear differential device 13b connects, for example, the rear rotating electric machine 11b and the left and right rear wheels Rr. Each of the differential devices 13a and 13b is, for example, a bevel gear type differential mechanism and is an open differential without a so-called differential limiting mechanism.

The first front brake mechanism 15FL and the second front brake mechanism 15FR are, for example, friction brake mechanisms provided respectively on the left and right front wheels Fr. The first rear brake mechanism 15RL and the second rear brake mechanism 15RR are, for example, friction brake mechanisms provided respectively on the left and right rear wheels Rr. Each of the brake mechanisms 15FL, 15FR, 15RL, and 15RR includes a disc brake, a drum brake, or the like connected to a hydraulic pressure generating unit 51 which will be described later, the hydraulic pressure generating unit 51 using, for example, a hydraulic pressure. The brake mechanisms 15FL, 15FR, 15RL, and 15RR perform friction braking on the front wheels Fr and the rear wheels Rr by a hydraulic pressure that an actuator of the hydraulic pressure generating unit 51 generates, for example, in response to an operator's operation on a brake operator.

The processing device 17 includes, for example, an electric braking control unit 21, a behavior control unit 23, a front motor control unit 25a, a rear motor control unit 25b, and an integrated control unit 27.

Each of the control units 21, 23, 25a, 25b, and 27 is a software functional unit that functions by a processor such as a central processing unit (CPU) executing a predetermined program. The software functional unit is an ECU that includes a processor such as a CPU, a read only memory (ROM) that stores programs, a random access memory (RAM) that temporarily stores data, and electronic circuits such as a timer. At least some of the control units 21, 23, 25a, 25b, 27 may be an integrated circuit such as a large scale integration (LSI).

The vehicle control system 10 of the embodiment includes, for example, the processing device 17 and various sensors mounted in the vehicle 1.

The processing device 17 acquires signals of detection values output from the various sensors of the vehicle 1 and performs overall control of the rotating electric machines 11a and 11b and the brake mechanisms 15FL, 15FR, 15RL, and 15RR. The various sensors include, for example, an operation amount sensor 31, a rotation sensor 33, an acceleration sensor 35, a wheel speed sensor 37, a current sensor 39, a voltage sensor 41, and a temperature sensor 43.

The operation amount sensor 31 includes, for example, a brake operation sensor that detects whether the operator has operated the brake operator and its amount of operation and an accelerator operation sensor that detects whether the operator has operated an accelerator operator and its amount of operation. The rotation sensor 33 detects the rotation angle of each of the rotating electric machines 11a and 11b. The acceleration sensor 35 detects the acceleration of the vehicle 1. The wheel speed sensor 37 detects the rotational speed (wheel speed) of each of the front wheels Fr and the rear wheels Rr (each wheel). The current sensor 39, the voltage sensor 41, and the temperature sensor 43 detect the current, voltage, and temperature of, for example, each of the rotating electric machines 11a and 11b and a power storage device such as a battery that transmits and receives electric power to and from each of the rotating electric machines 11a and 11b.

The electric braking control unit 21 controls, for example, the operation of the hydraulic pressure generating unit 51 that generates a hydraulic pressure for each of the brake mechanisms 15FL, 15FR, 15RL, and 15RR.

For example, the behavior control unit 23 controls friction braking of each of the brake mechanisms 15FL, 15FR, 15RL, and 15RR on the basis of a hydraulic pressure generated under the control of the electric braking control unit 21 in order to prevent sudden changes in the behavior of the vehicle 1 and stabilize the attitude thereof. The behavior control unit 23 performs, for example, anti-brake lock control to prevent wheel lock during braking, traction control to prevent slips of wheels (a slip of each wheel) during acceleration, deceleration, or the like, and sideslip prevention control during turning. For example, the behavior control unit 23 acquires signals of detection values output from the acceleration sensor 35 and the wheel speed sensor 37 and estimates the speed of the vehicle 1 (vehicle speed).

Each of the front motor control unit 25a and the rear motor control unit 25b includes, for example, a power conversion device connected to a power source such as a power storage device mounted in the vehicle 1. Each of the motor control units 25a and 25b controls electric power transfer to and from each of the front rotating electric machine 11a and the rear rotating electric machine 11b, for example, via a power conversion device including a plurality of switching elements or the like. During the motoring operation of the rotating electric machines 11a and 11b, the motor control units 25a and 25b cause current to sequentially flow to the three phases to generate a rotational driving force. During the regenerative operation of the rotating electric machines 11a and 11b, the motor control units 25a and 25b converts AC power input from the three phases into DC power through a switching operation of each phase synchronized with the rotation to generate a rotational braking force.

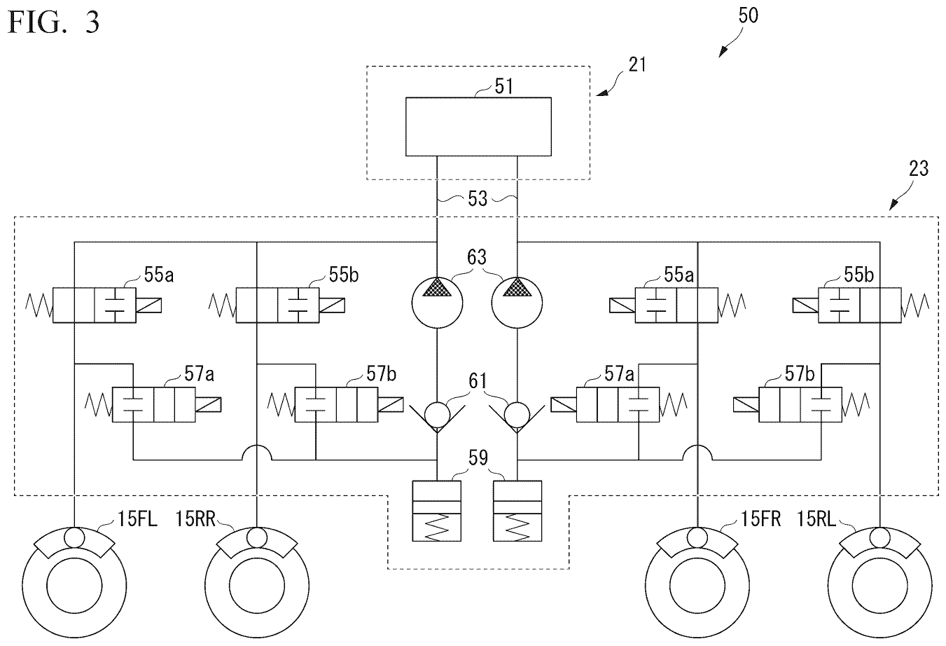

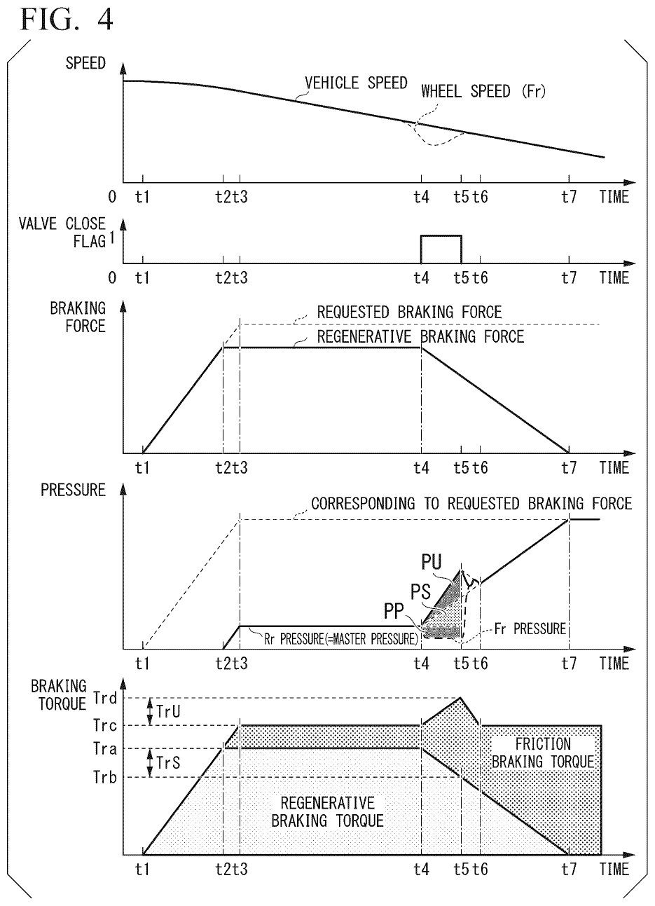

FIG. 3 is a configuration diagram of the hydraulic system 50 in the vehicle control system 10 of the embodiment.

As shown in FIG. 3, the hydraulic system 50 includes, for example, the hydraulic pressure generating unit 51, a medium flow path(s) 53, a first front valve(s) 55a, a first rear valve(s) 55b, a second front valve(s) 57a, a second rear valve(s) 57b, a reservoir tank(s) 59, a check valve(s) 61, and a pump(s) 63.

The hydraulic pressure generating unit 51 includes, for example, a hydraulic cylinder such as a master cylinder that generates a hydraulic pressure (a master pressure) and an actuator such as an electric motor that is a power source for the hydraulic cylinder. The medium flow path 53 is, for example, a flow path for a working medium (a pressure medium) such as hydraulic oil that transmits power.

The first front valve 55a and the first rear valve 55b are, for example, directional control valves. The valves 55a and 55b are arranged in medium flow paths 53 between the hydraulic pressure generating unit 51 and the brake mechanisms 15FL, 15FR, 15RL, and 15RR. For example, the valves 55a and 55b switch between flowing and blocking the working medium to the brake mechanisms 15FL, 15FR, 15RL, and 15RR.

The second front valve 57a and the second rear valve 57b are, for example, directional control valves. The valves 57a and 57b are arranged in medium flow paths 53 between the first front and rear valves 55a and 55b and the reservoir tank 59. For example, the valves 57a and 57b switch between flowing and blocking the working medium to the reservoir tank 59.

The reservoir tank 59 stores the working medium.

The check valve 61 is arranged in a medium flow path 53 between the reservoir tank 59 and the pump 63. The check valve 61 allows the working medium to flow from the reservoir tank 59 to the pump 63 and prohibits the working medium from flowing back from the pump 63 to the reservoir tank 59.

The pump 63 is arranged in a medium flow path 53 between the hydraulic pressure generating unit 51 and the first front and rear valves 55a and 55b. The pump 63 pumps out the working medium toward the hydraulic pressure generating unit 51.

In the hydraulic system 50, for example, when the first front valve 55a and the first rear valve 55b are in an open state, the working medium flows from the hydraulic pressure generating unit 51 to the brake mechanisms 15FL, 15FR, 15RL, and 15RR in parallel. For example, when the valves 55a and 55b are in an open state, the pressure of the working medium (an Fr pressure) applied to each of the front brake mechanisms 15FL and 15FR and the pressure (an Rr pressure) of the working medium applied to each of the rear brake mechanisms 15RL and 15RR become the same in response to the pressure of the working medium in the hydraulic pressure generating unit 51 (a master pressure). With the same pressure applied, the friction braking force of each of the front brake mechanisms 15FL and 15FR and the friction braking force of each of the rear brake mechanisms 15RL and 15RR are set in advance such that, for example, they have a predetermined front-to-back ratio using the size, friction material, and the like of each of the brake mechanisms 15FL, 15FR, 15RL, and 15RR.

An example of the operation of the vehicle control system 10 of the embodiment will be described below.

FIG. 4 is a diagram showing an example of a correspondence relationship between the speed of the vehicle 1, a valve close flag, the braking force, the pressure of the hydraulic system, and the braking torque in the vehicle control system 10 of the embodiment. In the example shown in FIG. 4, the vehicle 1 is in a front-wheel drive state in which the front rotating electric machine 11a generates torque (a driving torque and a regenerative braking torque) to the left and right front wheels Fr.

For example, when the vehicle 1 decelerates from time t1, the integrated control unit 27 acquires a braking force of the vehicle 1 requested by the driver (a requested braking force) in response to the driver's operation on the accelerator operator, the brake operator, and the like relating to deceleration of the vehicle 1.

First, for example, during a period from time t1 to time t2 in which the requested braking force increases in response to the driver's brake operation or the like, the integrated control unit 27 increases the regenerative braking force of the front rotating electric machine 11a via the front motor control unit 25a to generate a braking force corresponding to the requested braking force.

Next, for example, during a period from time t2 to time t3 in which the requested braking force increases in response to the driver's brake operation or the like, the integrated control unit 27 increases the master pressure of the hydraulic system 50 via the electric braking control unit 21 and the behavior control unit 23 to increase the friction braking force of each of the brake mechanisms 15FL, 15FR, 15RL, and 15RR. For example, the electric braking control unit 21 and the behavior control unit 23 open the valves 55a and 55b of the hydraulic system 50 and increase the master pressure of the hydraulic pressure generating unit 51 to increase the pressure of the working medium applied to each of the brake mechanisms 15FL, 15FR, 15RL, and 15RR. For example, when each of the valves 55a and 55b is open, the pressure of the working medium (an Fr pressure) applied to each of the front brake mechanisms 15FL and 15FR and the pressure (an Rr pressure) of the working medium applied to each of the rear brake mechanisms 15RL and 15RR are equal to the master pressure generated by the hydraulic pressure generating unit 51. The integrated control unit 27 generates a braking force corresponding to the requested braking force using the regenerative braking force of the front rotating electric machine 11a and the friction braking force of each of the brake mechanisms 15FL, 15FR, 15RL, and 15RR.

Next, when the requested braking force is constant, for example, from time t3 and the slip of the front wheels Fr and rear wheels Rr is not detected as in a period up to time t4, the integrated control unit 27 maintains the regenerative braking force of the front rotating electric machine 11a and the friction braking force of each of the brake mechanisms 15FL, 15FR, 15RL, and 15RR constant to generate a braking force corresponding to the requested braking force.

Next, for example, at time t4, the behavior control unit 23 starts performing anti-brake lock control upon detecting a slip of the front wheels Fr, for example, by the wheel speed of the front wheels Fr becoming less than a predetermined threshold value corresponding to the vehicle speed due to the traveling road changing to a low-friction road or the like. For example, the behavior control unit 23 switches the valve close flag for the first front valve 55a of the hydraulic system 50 from “0” indicating the open state to “1” indicating the closed state to block the flow of the working medium to each of the front brake mechanisms 15FL and 15FR. Due to the closed state of the first front valve 55a, the pressure of the working medium (the Fr pressure) applied to each of the front brake mechanisms 15FL and 15FR becomes at least equal to or lower than the master pressure at time t4 and changes from time t4, for example, such that the pressure of the working medium is constant or has a decreasing tendency. On the other hand, because the first rear valve 55b is maintained open, the pressure of the working medium (the Rr pressure) applied to each of the rear brake mechanisms 15RL and 15RR is always equal to the master pressure.

Then, for example, over a period from time t4 to time t5 during which the front wheels Fr continue to slip, the integrated control unit 27 changes the regenerative braking force of the front rotating electric machine 11a via the front motor control unit 25a and the electric braking control unit 21 such that the regenerative braking force has a decreasing tendency and changes the master pressure of the hydraulic pressure generating unit 51 such that the master pressure has an increasing tendency, thereby changing the pressure of the working medium applied to each of the rear brake mechanisms 15RL and 15RR (Rr pressure=master pressure) such that the pressure of the working medium has an increasing tendency. The electric braking control unit 21 increases the master pressure of the hydraulic pressure generating unit 51, for example, compared to when it increases the friction braking force according to the requested braking force and a reduction in the regenerative braking force in a state where no wheel slip occurs. For example, the electric braking control unit 21 increases the master pressure by a predetermined increase PU, in addition to an increase PS in the master pressure corresponding to replacing the regenerative braking force of the front wheels Fr with a friction braking force, to further raise the friction braking force. The Fr pressure PP shown in FIG. 4 is a decrease in the Fr pressure from time t4, for example, due to the closed state of the first front valve 55a.

The predetermined increase PU in the master pressure includes at least an increase required for the rear brake mechanisms 15RL and 15RR to compensate for an amount by which the increase PS in the master pressure has not been applied to the front brake mechanisms 15FL and 15FR due to the closed state of the first front valve 55a.

For example, the electric braking control unit 21 sets the friction braking force to a braking force (a second braking force) obtained by adding a predetermined braking force to a braking force (a first braking force) obtained by subtracting the regenerative braking force from the requested braking force. The first braking force is, for example, a total friction braking force that is set when the regenerative braking force is replaced with the friction braking force in a state where no wheel slip occurs. The second braking force is, for example, a total friction braking force that is set when the regenerative braking force is replaced with the friction braking force in a state where a slip occurs at driving wheels (for example, the front wheels Fr in front-wheel drive). The predetermined braking force is a braking force corresponding to the predetermined increase PU in the master pressure described above and a raised friction braking torque TrU described below.

The electric braking control unit 21 sets an increase in the friction braking torque corresponding to a decrease in the regenerative braking torque when replacing the regenerative braking force with the friction braking force, for example, from time t4 as a replacement friction braking torque TrS. For example, the electric braking control unit 21 sets a torque (a total increase in the friction braking torque) obtained by adding the replacement friction braking torque TrS and the raised friction braking torque TrU corresponding to the predetermined braking force described above as a total increased friction braking torque TrT (=TrS+TrU). The electric braking control unit 21 sets, for example, a torque obtained by multiplying the replacement friction braking torque TrS by a predetermined coefficient as a total increased friction braking torque TrT. For example, in the case of front-wheel drive, the predetermined coefficient is the reciprocal of a predetermined rear brake coefficient k (0<k<1) set for each of the rear brake mechanisms 15RL and 15RR. That is, the predetermined rear brake coefficient k indicates the ratio of the replacement friction braking torque TrS to the total increased friction braking torque TrT when the first front valve 55a is in a closed state. For example, the replacement friction braking torque TrS, the raised friction braking torque TrU, the total increased friction braking torque TrT (=TrU+TrS), and the predetermined rear brake coefficient k have a correspondence relationship expressed by the following formula.

Total increased friction braking torque TrT=Replacement friction braking torque TrS/k

Raised friction braking torque TrU=Replacement friction braking torque TrS×(1−k)/k

For example, in the period from time t4 to time t5, the replacement friction braking torque TrS is equal to a decrease in the regenerative braking torque (=Tra−Trb) from a regenerative braking torque Tra at time t4 to a regenerative braking torque Trb at time t5. The raised friction braking torque TrU is equal to an increase in the total braking torque (=Trd−Trc) from a total braking torque (=regenerative braking torque+friction braking torque=requested braking torque) Trc at time t4 to a total braking torque Trd (=regenerative braking torque+friction braking torque) at time t5.

Next, for example, at time t5, the behavior control unit 23 stops performing anti-brake lock control upon detecting elimination of the slip of the front wheels Fr, for example, by the wheel speed of the front wheels Fr becoming equal to or higher than a predetermined threshold value corresponding to the vehicle speed due to blocking of the flow of the working medium to each of the front brake mechanisms 15FL and 15FR and a decrease in the regenerative braking force. For example, the behavior control unit 23 switches the valve close flag for the first front valve 55a of the hydraulic system 50 from “1” indicating the closed state to “0” indicating the open state to release the blocking of the flow of the working medium to each of the front brake mechanisms 15FL and 15FR. Due to the open state of the first front valve 55a, the pressure of the working medium (the Fr pressure) applied to each of the front brake mechanisms 15FL and 15FR increases toward the master pressure. On the other hand, because the first rear valve 55b is maintained open, the pressure of the working medium (the Rr pressure) applied to each of the rear brake mechanisms 15RL and 15RR is equal to the master pressure.

When the first front valve 55a is switched from a closed state to an open state, the working medium is drawn into the front brake mechanisms 15FL and 15FR more than into the rear brake mechanisms 15RL and 15RR of the first rear valve 55b which is maintained in an open state, such that the master pressure (=Rr pressure) temporarily decreases as the Fr pressure increases. Then, after an appropriate period of time elapses, the master pressure (=Rr pressure) and the Fr pressure become the same as a predetermined equilibrium pressure.

The electric braking control unit 21 increases the master pressure of the hydraulic pressure generating unit 51 by the predetermined increase PU in advance, for example, during the period from time t4 to time t5 as described above, such that even if when the master pressure temporarily decreases, for example, from time t5, the friction braking force is prevented from becoming insufficient with respect to the requested braking force.

Then, the electric braking control unit 21 gradually reduces the predetermined increase PU toward zero, for example, over a period up to time t6 in order to prevent the friction braking force from becoming excessive with respect to the requested braking force after the master pressure temporarily decreases, for example, from time t5. For example, the predetermined period of time from time t5 to time t6 is set to be at least longer than the time required for the master pressure (=Rr pressure) and the Fr pressure to become equal to a predetermined equilibrium pressure.

The electric braking control unit 21 reduces the predetermined increase PU in the master pressure toward zero, for example, over the period from time t5 to time t6, such that the raised friction braking torque TrU corresponding to the predetermined braking force described above decreases toward zero.

Next, for example, over a period from time t6 to time t7, the integrated control unit 27 replaces the regenerative braking force of the front wheels Fr with the friction braking force of the front wheels Fr and the rear wheels Rr until the regenerative braking force of the front wheels Fr becomes zero and ensures the requested braking force only by the friction braking force.

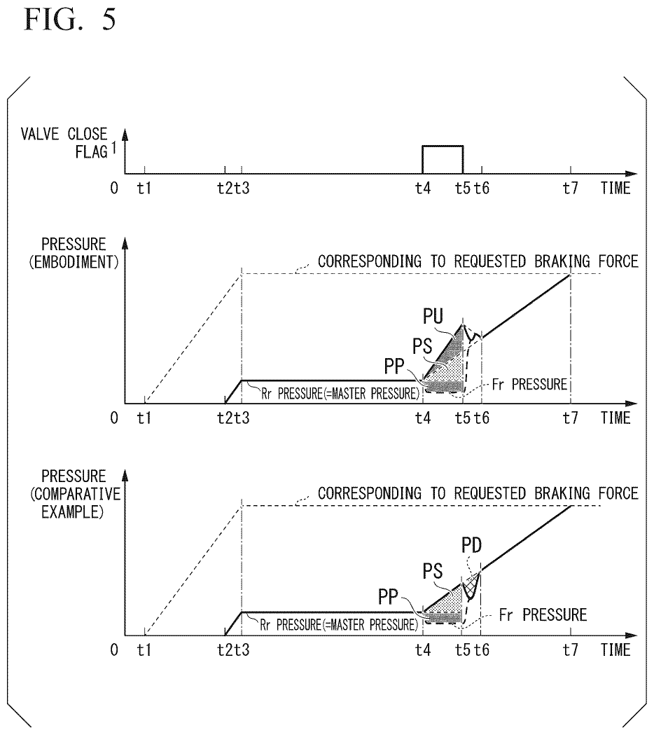

FIG. 5 is a diagram showing an example of a correspondence relationship between the valve close flag and the pressure of the hydraulic system 50 in the vehicle control system 10 of the embodiment and a comparative example.

In the embodiment and the comparative example shown in FIG. 5, the regenerative braking force of the front wheels Fr is replaced with a friction braking force after the first front valve 55a of the hydraulic system 50 is closed by performing anti-brake lock control, for example, from time t4 to time t5.

In the embodiment, a predetermined increase PU in the master pressure required for the rear wheels Rr to compensate for an amount by which the increase PS in the master pressure corresponding to replacing the regenerative braking force with the friction braking force has not been applied to the front wheels Fr from time t4 is set as described above. The comparative example is, for example, a case where the predetermined increase PU in the master pressure is not set.

In each of the embodiment and the comparative example, when the first front valve 55a of the hydraulic system 50 is switched from a closed state to an open state by stopping performing the anti-brake lock control, for example, from time t5, the master pressure (=Rr pressure) temporarily decreases as the Fr pressure increases.

In the comparative example, because the master pressure of the hydraulic pressure generating unit 51 is not increased by a predetermined increase amount PU in advance, the master pressure temporarily decreases, for example, from time t5, such that the friction braking force becomes insufficient with respect to the requested braking force. For example, due to a decrease in the friction braking force corresponding to a decrease PD in the master pressure in the comparative example, it is not possible to ensure a friction braking force required for the requested braking force (=requested braking force-regenerative braking force).

In contrast, in the embodiment, the master pressure of the hydraulic pressure generating unit 51 is increased by a predetermined increase PU in advance, such that even if the master pressure temporarily decreases, for example, from time t5, it is possible to ensure the master pressure necessary to obtain a friction braking force required for the requested braking force (=requested braking force-regenerative braking force).

According to the vehicle control system 10 of the embodiment, when a slip has occurred at the front wheels Fr that performs regenerative braking, the behavior control unit 23 can promote elimination of the slip by blocking the flow of the working medium to each of the front brake mechanisms 15FL and 15FR and replacing the regenerative braking torque of the front wheels Fr with a friction braking torque as described above. The electric braking control unit 21 increases the pressure (the master pressure) of the working medium flowing to each of the rear brake mechanisms 15RL and 15RR compared to when no slip occurs, such that it is possible to prevent the total friction braking force of the vehicle from becoming insufficient. The electric braking control unit 21 sets a predetermined increase PU in the master pressure, such that it is possible to prevent insufficient braking force and vehicle behavior instability when eliminating a slip of the front wheels Fr.

The integrated control unit 27 can promote the elimination of the slip of the front wheels Fr by replacing the regenerative braking torque of the front wheels Fr with a friction braking torque. The electric braking control unit 21 can prevent the total braking force (the sum of the friction braking force and the regenerative braking force) of the vehicle from becoming insufficient by setting an increase in the master pressure required for the real wheels Rr to compensate for an amount by which the increase PS in the master pressure corresponding to the replacement has not been applied to the front wheels Fr due to the closed state of the front valve 55a as a predetermined increase PU.

With the predetermined increase PU in the master pressure, the electric braking control unit 21 can deal with the temporary decrease in the master pressure upon switching the first front valve 55a to the open state when eliminating the slip of the front wheels Fr and prevent the total friction braking force and the overall braking force of the vehicle from becoming insufficient.

The electric braking control unit 21 reduces the predetermined increase PU in the master pressure toward zero over a predetermined period of time when the slip of the front wheels Fr has been eliminated, such that it is possible to prevent the total friction braking force of the vehicle from becoming excessive and prevent sudden fluctuations in the friction braking force and vehicle behavior instability.

### MODIFICATIONS

Hereinafter, modifications of the embodiment will be described. The same parts as those in the embodiment described above are given the same reference numerals and description thereof will be omitted or simplified.

In the embodiment described above, the vehicle 1 is in a front-wheel drive state in which the front rotating electric machine 11a generates torque (a driving torque and a regenerative braking torque) to the left and right front wheels Fr as in the example shown in FIG. 4, but the present invention is not limited thereto. The vehicle 1 may be, for example, in a rear-wheel drive state in which the rear rotating electric machine 11b generates torque (a driving torque and a regenerative braking torque) to the left and right rear wheels Rr or in an all-wheel drive state in which the rotating electric machines 11a and 11b and the like generate torque to all wheels.

For example, in the case of rear-wheel drive, when a slip of the rear wheels Rr occurs, the behavior control unit 23 switches the first rear valve 55b of the hydraulic system 50 from an open state to a closed state by performing anti-brake lock control to block the flow of the working medium to each of the rear brake mechanisms 15RL and 15RR. Then, for example, over a period during which the rear wheels Rr continue to slip, the integrated control unit 27 changes the regenerative braking force of the rear rotating electric machine 11b such that the regenerative braking force has a decreasing tendency and changes the master pressure of the hydraulic pressure generating unit 51 such that the master pressure has an increasing tendency, thereby changing the pressure of the working medium (Fr pressure=master pressure) applied to each of the front brake mechanisms 15FL and 15FR such that the pressure of the working medium has an increasing tendency.

For example, in the case of rear-wheel drive, the predetermined coefficient by which the replacement friction braking torque TrS is multiplied to set the total increased friction braking torque TrT is the reciprocal of a predetermined front brake coefficient h set for each of the front brake mechanisms 15FL and 15FR. The predetermined front brake coefficient h is, for example, h=1−k, given the predetermined rear brake coefficient k in the embodiment. For example, when the first rear valve 55b is in a closed state, the replacement friction braking torque TrS, the raised friction braking torque TrU, the total increased friction braking torque TrT (=TrU+TrS), and the predetermined front brake coefficient h (=1−k) have a correspondence relationship expressed by the following formula.

Total increased friction braking torque TrT=Replacement friction braking torque TrS/(1−k)

Raised friction braking torque TrU=Replacement friction braking torque TrS×k/(1−k)

In the embodiment described above, the vehicle 1 includes the front rotating electric machine 11a connected to the left and right front wheels Fr and the rear rotating electric machine 11b connected to the left and right rear wheels Rr, but the present invention is not limited thereto. For example, each wheel may be individually provided with a rotating electric machine or each appropriate combination of wheels may be individually provided with a rotating electric machine.

In the embodiment described above, the predetermined increase PU in the master pressure is an increase in the master pressure required for the real wheels Rr to compensate for an amount by which the increase PS in the master pressure corresponding to replacing the regenerative braking force with the friction braking force has not been applied to the front wheels Fr due to the closed state of the front valve 55a, but the present invention is not limited thereto. For example, the predetermined increase PU may further include an increase required for the real wheels Rr to compensate for the decrease PP in the Fr pressure by which the behavior control unit 23 has reduced the Fr pressure. For example, in the case of rear-wheel drive or all-wheel drive, the terms “front wheels Fr” and “rear wheels Rr” may be replaced with each other.

Although embodiments of the present invention have been described, these embodiments have been presented by way of example and are not intended to limit the scope of the invention. These embodiments can be implemented in various other forms, and various omissions, substitutions, and changes can be made without departing from the spirit of the invention. These embodiments and modifications thereof are included in the scope or spirit of the invention as well as in the scope of the invention described in the claims and their equivalents.

What is claimed is:

1. A vehicle control system comprising:
a rotating electric machine control unit configured to control an operation of a rotating electric machine configured to transmit and receive torque to and from a predetermined wheel; and
a friction braking control unit configured to control an operation of a pressure system configured to drive a friction brake mechanism of a plurality of wheels including the predetermined wheel using a pressure medium,
wherein the friction braking control unit is configured to, when a slip of the predetermined wheel has occurred during execution of regenerative braking by the rotating electric machine control unit, block a flow of the pressure medium to the friction brake mechanism of the predetermined wheel and increase a pressure of the pressure medium compared to when the slip of the predetermined wheel has not occurred.

2. The vehicle control system according to claim 1, wherein the friction braking control unit is configured to set the pressure of the pressure medium in association with a friction braking torque obtained by multiplying a decrease in a regenerative braking torque by which the rotating electric machine control unit has reduced the regenerative braking torque by a predetermined coefficient while the flow of the pressure medium to the friction brake mechanism of the predetermined wheel is blocked when a slip of the predetermined wheel has occurred to increase the pressure of the pressure medium compared to when the slip of the predetermined wheel has not occurred.

3. The vehicle control system according to claim 1, wherein the friction braking control unit is configured to, when the blocking of the flow of the pressure medium to the friction brake mechanism of the predetermined wheel has been released, terminate control of increasing the pressure of the pressure medium compared to when the slip of the predetermined wheel has not occurred after a predetermined period of time elapses.
